(19) United States
(12) Patent Application Publication
(10) Pub. No.: US 2005/0023119 A1
(43) Pub. Date: Feb. 3, 2005

(54) Restorable conductive elastic connector

(76) Inventor: Yao Tsun Lu, Taipei (TW)

Correspondence Address: Yao Tsun Lu, 235 Chung-Ho, Box 8-24, Taipei, TW

(21) Appl. No.: 10/628,798

(22) Filed: Jul. 29, 2003

(51) Int. Cl. H01H 1/06

(52) U.S. Cl. 200/276

(57) ABSTRACT

A restorable conductive elastic connector comprises: an element capable of being sucked by a sucking unit of a machining device; the element being transferred by the machining device to be adhered to a machining object to be as a conductive elastic connector. The sucking unit has an air channel. The air channel is extended with an outlet at a bottom of a sucking unit. The outlet has a tapered shape and the air channel has a sucking ability in negative pressure. The element is made of conductive helical spring, which is wound as a sandglass; that is, a waist portion is narrow than a top portion and a bottom portion. The element can be sucked to the tapered outlet of the sucking unit.

### FIELD OF THE INVENTION

The present invention relates to connectors, and particularly to a restorable conductive elastic connector, which is made of a helical spring and the shape is like a sandglass. The restorable conductive elastic connector is especially to be used for a machining device, with a sucking unit. By the sucking unit, the connector could be moved and adhered to a machining object. Then, the machining object could be sucking and moving stably by the machine device, and transmit the signal through the connector.

### BACKGROUND OF THE INVENTION

The machine device with a sucking unit that is indicated in the present invention is as the Surface Mounted Device (SMD), that we could find everywhere. SMD—the machine device with Surface Mounted Technology (SMT)—is installed a sucking unit, which has the sucking ability under the negative pressure, so can suck the component or machining object to be moved coordinately and to be machined in SMD. It can be any kinds of the components, such as conductive elastic connector of the present invention, resistor, capacitor, transistor, etc., that shall be inserted or adhered to the machining object. The machining object could be a printed circuit board (PCB). In other words, the relationship between the component and the machining object is including the connection of the signal for different kinds of electronic products.

Currently, the technology that using the conductive elastic connector as the inline package, and to be sucked and adhered to the PCB, machining object through the sucking unit of the SMT is known in U.S. Pat. No. 6,239,393. It discloses the devices that apply to connecting the PCB by SMD. It contains a spring adhering in PCB and a sucking unit placing on a SMT machine device. Then, during the SMD process, the structure between spring and the sucking unit can improve the process of sucking, moving and adhering to be more smoothly.

However, the U.S. Pat. No. 6,239,393 is only suitable for special specification, and the machining cost is high. Thereby, it cannot be used widely. Moreover, the difference of diameter between the top and bottom of the spring is too big, that causes the spring inclined in the reel tank easily. Due to that, the process of sucking will be impeded. Furthermore, the length of the spring element is too long it will not be pressed during the sucking process to PCB, that causes a large gap between the sucking unit and the surface of the PCB. It is not benefic to the sucking machine to suck the PCB under the negative pressure, so that effects the stability of the operation of the sucking unit. Therefore, the machining of the SMD can not work smoothly.

### SUMMARY OF THE INVENTION

The primary of the present invention is to provide the restorable conductive elastic connector, which is made of a helical spring, with the function of self-correction in reel tank; and could be the conductive connector to the machining object. First, the present invention can match the sucking unit to keep itself be sucked well and stably. Secondary, in the present invention, diameter of the top is smaller than the bottom, so when the reel is moving, each single connector could correct its place to keep in the center and not impend in the cavity. Third, the surface of the present invention is finished by conductive material (now is Au), and its bottom will be adhered to the position of the conductive of the machining object, so it could be take as the conductive connector for the machining object. Finally, the shape like the waist is in the present invention. The waist, its diameter is smaller than the top and the bottom. So, it causes a great compressive distance when it is adhering to the PCB, and improves the stability of the sucking and moving process.

The various objects and advantages of the present invention will be more readily understood from the following detailed description when read in conjunction with the appended drawing.

### BRIEF DESCRIPTION OF THE DRAWINGS

FIG. 1: The front view of the connector of the present invention.

FIG. 2: The cross-section—the present invention is in the reel and its top position is be sucked by a sucking unit.

FIG. 3: The cross-section—the present invention is sucked by a sucking unit.

FIG. 4: The schematic—the present invention is adhered to a machining object.

FIG. 5: The enlarged cross sectional—the present invention is sucked by a sucking unit.

### DETAILED DESCRIPTION OF THE INVENTION

In order to have a further understanding of the present invention, a detail description will be described in the following. However, these descriptions and the appended drawings are only used to cause those skills in the art to be understood but not to be used to confine the scope and spirit of the present invention defined in the claims.

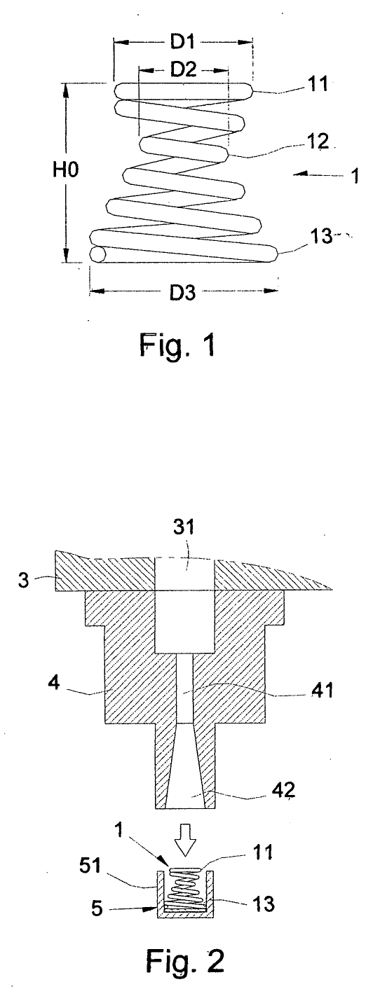

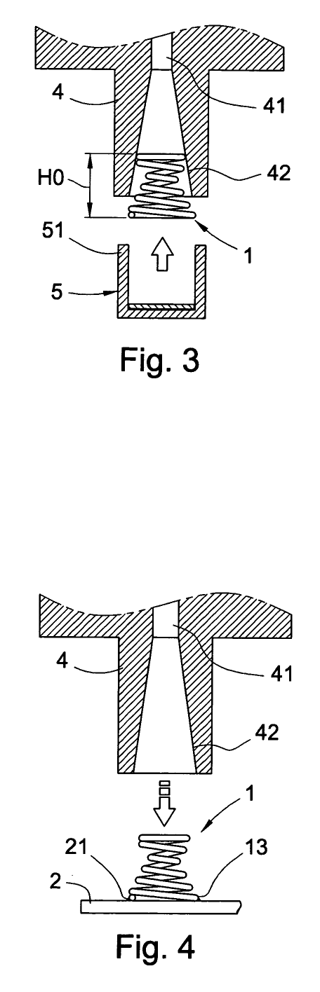

Refer to FIG. 1, a front view of the conductive elastic element 1 of the present invention. The element 1 is made of a conductive compressible spring with a shape like a sandglass. The element 1 has a wide top portion 11, a narrow waist portion 12, and a width bottom portion 13.

The description of the present invention is illustrated in FIG. 1. No. 1: Conductive elastic element. It is made of the conductive compressible spring, and its shape like a sandglass. And it is formed with a helical spring with the part No. 11, 12, 13. No. 11: The top portion. No. 12: The waist portion. No. 13: The bottom portion.

The outer diameter D1 of the top portion 11 is smaller than the outer diameter D3 of the bottom portion 13, as shown in FIG. 1. Thereby, when the element 1 is placed between and resisted against the tank wall 51 (shown in FIG. 2) of a reel tank 5 (shown in FIG. 2) the center point of the spring will not tilt. Thus, the present invention has the ability of self-restoration.

Thereby, when the sucking unit 4 (shown in FIG. 2) of the machining device 3 (shown in FIG. 2), that is described hereinafter sucks the element 1 in the reel tank, the element 1 can be sucked accurately.

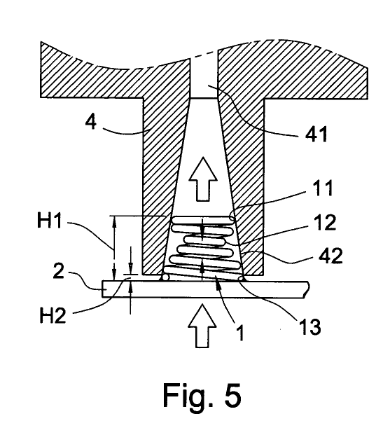

Moreover, the outer diameter D2 of the waist portion 12 of the element 1 is smaller than the outer diameter D1 of the top portion 11 outer diameter D3 of the bottom portion 13, as shown in FIG. 1. When the element 1 is under pressed, the normal height (H0) is compressed to the H1—which causes the perfect compressibility for element 1 (referring to FIG. 5).

The sucking unit 4 has an air channel 41, which is communicable to the joint 31 of the negative pressure source. The portion of the air channel 41 extends to the lower outlet of the sucking unit 4 will be made as a tapered opening 42 (referring to FIG. 2). The self-restored element 1 in the reel tank 5 can be sucked accurately in the tapered opening 42 through sucking unit 4.

Refer to FIG. 4, through the machine device 3, for example: SMT machine device, the sucking unit can move element 1 to the conductive point 21 of the machining object 2 for soldering or adhering. So the element 1 can be stable at machining object 2. Because of the element 1 is conductive (finished by Au), when it is connected with conductive point 21, the element 1 becomes the conductive connector for the machining object 2.

Furthermore, when above element 1 is adhered on the machining object 2, and if it is needed to move the machining object 2 for machining, the sucking unit 4 of the machine device 3 will suck the machining object 2 through the element 1.

It is appreciated from above description that in the present invention, the helical spring has the function of correction in the reel tank 5 and thus it is suitable to be as the conductive connector of a machining object 2. Moreover, the reduced waist of the element has provided a larger compressible distance so that the sucking unit 4 can elastically suck a machining object 2 and move the machining object 2 stably. Otherwise, the element of the present invention can be made easily with a lower cost and have a high tolerance and high stability. Thereby, it can be assembled and detached easily and conveniently. And, no other prior art can be used with a sucking unit 4.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications will be embraced within th scope of the invention as defined in the claims.

1. A restorable conductive elastic connector comprising: a connector capable of being sucked by a sucking unit of a machining device; the connector being transferred by the machining device and then be adhered to a machining object; the sucking unit has an air channel; the air channel being extended with an outlet portion at a bottom of the sucking unit; the outlet section having a tapered shape and the air channel having a sucking ability under negative pressure; characterized as:
The connector is made of conductive helical spring, which is wound as a sandglass; that is, a waist portion of the helical spring is narrow than a top portion and a bottom portion thereof; and the connector can be sucked to the outlet section of the sucking unit.

2. The restorable conductive elastic connector as claimed in claim 1, wherein the machining device is a SMT (surface mounting technology) machining device using in surface mounting device.

3. The restorable conductive elastic connector as claimed in claim 1, wherein the machining object is a printed circuit board.

4. The restorable conductive elastic connector as claimed in claim 1, wherein the machining object is conduction means for conducting electronic signals of an electronic device.

5. The restorable conductive elastic connector as claimed in claim 1, wherein the element is restorable in a reel tank.

6. The restorable conductive elastic connector as claimed in claim 1, wherein the element is fixed to the machining object and then is sucked by a sucking unit and thus compressed so that the distance connected a bottom of the sucking unit and a surface of the machining object is reduced.
